(19) United States
(12) Patent Application Publication
(10) Pub. No.: US 2003/0135502 A1
(43) Pub. Date: Jul. 17, 2003

(54) Multi-server computer system with self-initiating database replication utility

(75) Inventors: Timothy Hun, Jubei City (TW); Chien-Chuan Chen, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/044,363

(22) Filed: Jan. 11, 2002

(51) Int. Cl. G06F 7/00

(52) U.S. Cl. 707/100

(57) ABSTRACT

Within both a multi-server computer system, and a method for operation thereof, there is provided a plurality of server computers comprising: (1) a corresponding series of databases; (2) a corresponding series of database update detection and installation utilities; and (3) a corresponding series of communications interfaces which connect the plurality of server computers with each other. The series of database update detection and installation utilities serves to both: (1) automatically detect an externally initiated update to a database within the corresponding series of databases and automatically forward the externally initiated update to each of the remaining server computers within the plurality of server computers; and (2) automatically receive the externally initiated update from a server computer within the plurality of server computers and install the update within the remaining databases within the remaining server computers.

### BACKGROUND OF THE INVENTION

1. Field of the Invention

The present invention relates generally to computer systems. More particularly, the present invention relates to multi-server computer systems.

2. Description of the Related Art

Coincident with the pervasive development of high performance information technology applications within various information technology environments, including in particular world wide web (WWW) information technology environments, there has been a correlating development of high performance computer systems with sufficiently enhanced speed and sufficiently enhanced capacity such as to adequately support the hardware requirements of the high performance information technology applications. Of the types of high performance computer systems which are often employed in high performance information technology applications, multi-server computer systems are often of considerable interest.

Multi-server computer systems are desirable in support of high performance information technology applications insofar as multi-server computer systems are often quite favorably cost competitive in comparison with equivalent performance single-server computer systems which might otherwise be employed in support of high performance information technology applications.

While multi-server computer systems are thus desirable in the art of information technology and often essential in the art of information technology, multi-server computer systems are nonetheless not entirely without problems in the art of information technology.

In that regard, it is often difficult in the art of information technology to provide multi-server computer systems with enhanced database update and replication capabilities.

It is thus desirable in the art of information technology to provide multi-server computer systems, and methods for operation thereof, which in turn provide enhanced database update and replication capabilities within the multi-server computer systems.

It is towards the foregoing objects that the present invention is directed.

Various multi-server computer systems having desirable properties, and methods for operation thereof, have been disclosed within the art of information technology.

Included among the multi-server computer systems and methods for operation thereof, but not limiting among the multi-server computer systems and methods for operation thereof, are multi-server computer systems and methods for operation thereof disclosed within: (1) Brendel et al., in U.S. Pat. No. 5,774,660 (a world wide web (WWW) server multi-server computer system with enhanced load balancing capabilities by, in-part, delaying a load balancing within the world wide web (WWW) server multi-server computer system until after a location of a requested resource is ascertained within the world wide web (WWW) server multi-server computer system); and (2) Colyer, in U.S. Pat. No. 6,023,722 (a world wide web (WWW) server multi-server computer system with enhanced load balancing capabilities, by employing a router type messaging and queuing unit from which individual server computers within the world wide web (WWW) server multi-server computer system pull resource requests).

Desirable in the art of information technology are multi-server computer systems, and methods for operation thereof, which in turn provide enhanced database update and replication capabilities within the multi-server computer systems.

It is towards the foregoing objects that the present invention is directed.

### SUMMARY OF THE INVENTION

A first object of the present invention is to provide a multi-server computer system, and a method for operating the multi-server computer system.

A second object of the present invention is to provide a multi-server computer system and a method for operating the multi-server computer system in accord with the first object of the present invention, wherein multi-server computer system and the method for operating the multi-server computer system provide for enhanced database update and replication capabilities within the multi-server computer system.

A third object of the present invention is to provide a multi-server computer system and a method for operating the multi-server computer system in accord with the first object of the present invention and the second object of the present invention, wherein the multi-server computer system and the method for operating the multi-server computer system are readily commercially implemented.

In accord with the objects of the present invention, there is provided by the present invention a multi-server computer system and a method for operating of the multi-server computer system.

In accord with the present invention, the multi-server computer system comprises a plurality of server computers in turn comprising: (1) a corresponding series of databases; (2) a corresponding series of database update detection and installation utilities; and (3) a corresponding series of communications interfaces which connect the plurality of server computers with each other. Within the multi-server computer system of the present invention, the series of database update detection and installation utilities serves to both: (1) automatically detect an externally initiated update to a database within the corresponding series of databases and automatically forward the externally initiated update to each of the remaining server computers within the plurality of server computers through the series of communications interfaces; and (2) automatically receive the externally initiated update through the series of communications interfaces from a server computer within the plurality of server computers and install the update within the remaining databases within the remaining server computers which receive the update through the series of communications interfaces.

The multi-server computer system of the present invention contemplates a method for operating the multi-server computer system of the present invention.

The present invention provides a multi-server computer system and a method for operating the multi-server computer system, wherein the multi-server computer system and the method for operating the multi-server computer system provide for enhanced database update and replication capabilities within the multi-server computer system.

The present invention realizes the foregoing object by providing within the multi-server computer system of the present invention, and the method for operating the multi-server computer system of the present invention, and with respect to a plurality of server computers comprising a corresponding series of databases and a corresponding series of communications interfaces, a corresponding series of database update detection and installation utilities which serves to both: (1) automatically detect an externally initiated update to a database within the corresponding series of databases and automatically forward the externally initiated update to each of the remaining server computers within the plurality of server computers through the series of communications interfaces; and (2) automatically receive the externally initiated update through the series of communications interfaces from a server computer within the plurality of server computers and install the update within the remaining databases within the remaining server computers which receive the update through the series of communications interfaces.

The multi-server computer system in accord with the present invention, and the method for operating the multi-server computer system in accord with the present invention, are readily commercially implemented.

As will be illustrated in greater detail within the context of the Description of the Preferred Embodiment, as set forth below, the multi-server computer system of the present invention, and the method for operating the multi-server computer system of the present invention, may be effected while employing server computers and related components as are otherwise generally conventional in the art of computer system design and implementation, but assembled and programmed such as to provide the multi-server computer system of the present invention.

Since it is thus at least in system design considerations and computer algorithm considerations which provide at least in part the present invention, rather than the existence of server computers and related components which provide the present invention, the multi-server computer system of the present invention and the method for operating the multi-server computer system of the present invention are readily commercially implemented.

### BRIEF DESCRIPTION OF THE DRAWINGS

The objects, features and advantages of the present invention are understood within the context of the Description of the Preferred Embodiment, as set forth below.

The Description of the Preferred Embodiment is understood within the context of the accompanying drawings, which form a material part of this disclosure, wherein:

FIG. 1 shows a schematic block diagram illustrating a multi-server computer system in accord with a preferred embodiment of the present invention.

FIG. 2 shows a schematic block diagram illustrating in greater detail a series of server computers and related components within the multi-server computer system in accord with the preferred embodiment of the present invention.

FIG. 3 shows a series of lines of PHP-XML programming code which may be employed within a database update detection and installation utility for use within a server computer within the multi-server computer system in accord with the preferred embodiment of the present invention.

### DESCRIPTION OF THE PREFERRED EMBODIMENT

The present invention provides a multi-server computer system and a method for operating the multi-server computer system, wherein the multi-server computer system and the method for operating the multi-server computer system provide for enhanced database update and replication capabilities within the multi-server computer system.

The present invention realizes the foregoing object by providing within the multi-server computer system of the present invention, and the method for operating the multi-server computer system of the present invention, and with respect to a plurality of server computers comprising a corresponding series of databases and a corresponding series of communications interfaces, a corresponding series of database update detection and installation utilities which serves to both: (1) automatically detect an externally initiated update to a database within the corresponding series of databases and automatically forward the externally initiated update to each of the remaining server computers within the plurality of server computers through the series of communications interfaces; and (2) automatically receive the externally initiated update through the series of communications interfaces from a server computer within the plurality of server computers and install the update within the remaining databases within the remaining server computers which receive the update through the series of communications interfaces.

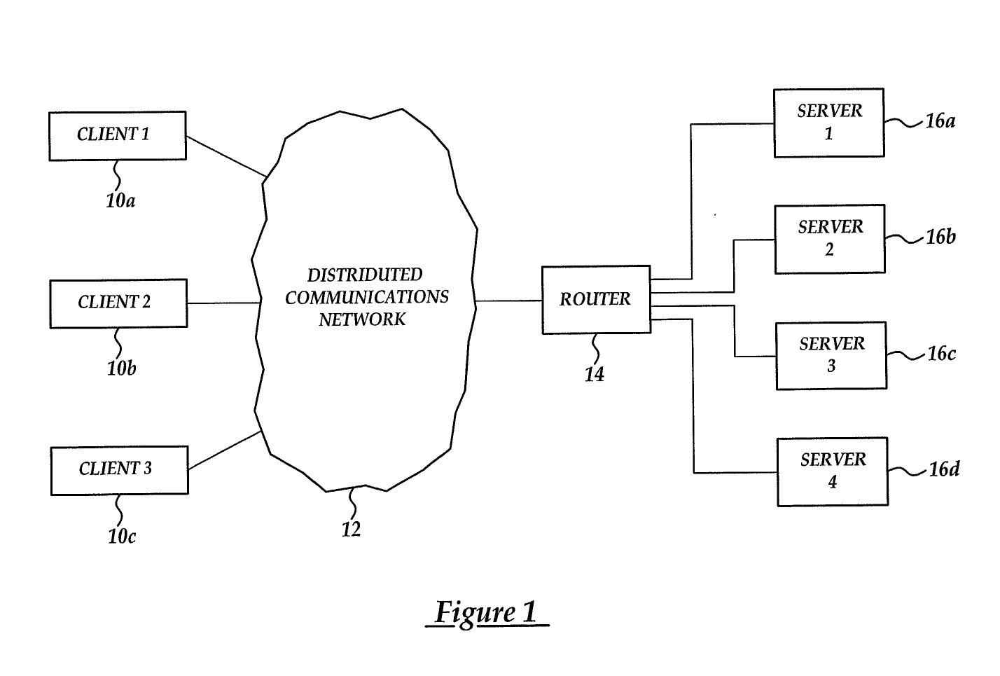

Referring now to FIG. 1, there is shown a schematic block diagram illustrating a multi-server computer system in accord with a preferred embodiment of the present invention.

Shown in FIG. 1, in a first instance, is a series of clients 10a, 10b and 10c, where each of the series of clients 10a, 10b and 10c independently accesses a distributed communications network 12 through a direct connection to the distributed communications network.

Within the present invention, the distributed communications network 12 may be selected from the group including but not limited to local area network (LAN) distributed communications networks, wide area network (WAN) distributed communications networks, intranet distributed communications networks and Internet distributed communications networks. However, for the preferred embodiment of the present invention, the distributed communications network 12 is typically and preferably an Internet distributed communications network.

Within the present invention with respect to the series of clients 10a, 10b and 10c, each of the series of clients 10a, 10b and 10c is matched with respect to the nature of the distributed communications network 12 to which it is connected. In that regard, and within the context of the preferred embodiment of the present invention where the distributed communications network 12 is typically and preferably an Internet distributed communications network which generally incorporates a world wide web (WWW) Internet distributed communications network component, the series of clients 10a, 10b and 10c is typically and preferably a series of personal computers or workstations which operate world wide web (WWW) browsing software and related distributed communications network access and communication software as is otherwise generally conventional in the art of information technology.

Shown also within the schematic cross-sectional diagram of FIG. 1, and also connected to the distributed communications network 12, is a router 14, where the router 14 in turn has connected thereto a series of server computers 16a, 16b, 16c and 16d.

Within the preferred embodiment of the present invention with respect to both the router 14 and the series of server computers 16a, 16b, 16c and 16d, both the router 14 and the series of server computers 16a, 16b, 16c and 16d may be provided within the context of hardware components are otherwise generally conventional in the art of information technology.

As is understood by a person skilled in the art, the multi-server computer system whose schematic cross-sectional diagram is illustrated in FIG. 1 is typically employed under circumstances where a number of clients, such as the clients 10a, 10b and 10c, in an aggregate make a sufficiently large number of resource requests such that responses to the resource requests may not generally be efficiently provided while employing only a single-server computer system. Similarly, under such circumstances, it is often common for at least portions of database content within the series of server computers 16a, 16b, 16c and 16d to be identical, such that the router may indiscriminately direct resource requests from a series of clients, such as the series clients 10a, 10b and 10c, to any of a series of server computers, such as the series of server computers 16a, 16b, 16c and 16d.

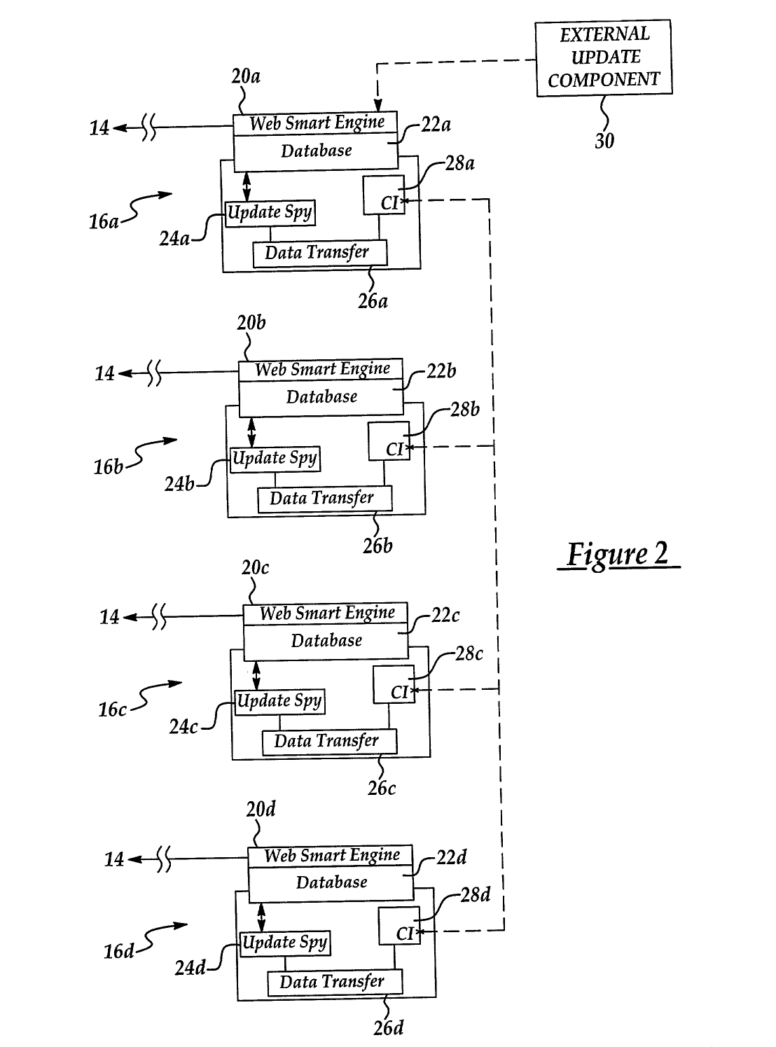

Referring now to FIG. 2, there is shown a schematic block diagram illustrating in greater detail the series of server computers 16a, 16b, 16c and 16d as illustrated within the multi-server computer system whose schematic block diagram is illustrated in FIG. 1.

As is shown within the schematic block diagram of FIG. 2, each of the series of server computers 16a, 16b, 16c and 16d has contained therein a web smart engine 20a, 20b, 20c or 20d which is connected to the router 14 as illustrated within the schematic block diagram of FIG. 1. Similarly, each of the series of server computers 16a, 16b, 16c and 16d also has associated with the series of web smart engines 20a, 20b, 20c and 20d a corresponding series of databases 22a, 22b, 22c or 22d. Incident to processing effected by the series of web smart engines 20a, 20b, 20c and 20d, requests by a client 10a, 10b or 10c for resources within the series of databases 22a, 22b, 22c and 22d may be fulfilled and in return the requested resources may be forwarded to the requesting client 10a, 10b or 10c. Within the present invention and the preferred embodiment of the present invention, both the series of web smart engines 20a, 20b, 20c and 20d, and the series of databases 22a, 22b, 22c and 22d, are intended as incorporating both hardware components and software components.

Also illustrated within the schematic block diagram of FIG. 2, and interacting with each of the series of databases 22a, 22b, 22c and 22d, is a corresponding series of update spies 24a, 24b, 24c and 24d, in turn connected to a corresponding series of data transferors 26a, 26b, 26c and 26d, finally in turn connected to a corresponding series of communications interfaces 28a, 28b, 28c and 28d.

Within the preferred embodiment of the present invention with respect to the series of update spies 24a, 24b, 24c and 24d, the series of update spies 24a, 24b, 24c and 24d is intended to at least routinely, and preferably continuously, monitor the series of databases 22a, 22b, 22c and 22d, such as to ascertain if any of the series of databases 22a, 22b, 22c and 22d has been modified or updated through use of a computer system component generally external to the series of computer system components as illustrated within the schematic block diagram of FIG. 1. Such an external computer system component may comprise, for example and without limitation, a keyboard which is attached to the web smart engine 20a, and is generally illustrated within the schematic block diagram of FIG. 2 as external update component 30. Such an externally initiated update will typically and preferably, but not necessarily, be undertaken by a computer systems engineer or a computer systems administrator who is otherwise responsible for operation of the series of server computers 16a, 16b, 16c and 16d as illustrated within the schematic block diagram of FIG. 2.

Within the preferred embodiment of the present invention with respect to series of data transferors 26a, 26b, 26c and 26d, the series of data transferors 26a, 26b, 26c and 26d is intended, in a first instance, to provide a series of connections between the series of update spies 24a, 24b, 24c and 24d and the series of communications interfaces 28a, 28b, 28c and 28d.

Similarly, in a second instance, the series of data transferors 26a, 26b, 26c and 26d is also intended to: (1) automatically forward an externally initiated update within one of the series of databases 22a, 22b, 22c and 22d either directly or indirectly to each of the remaining server computers 16a, 16b, 16c or 16d within the plurality of server computers 16a, 16b, 16c and 16d; and (2) automatically receive the externally initiated update (which is now an internally initiated update) within the one of the series of databases 22a, 22b, 22c and 22d from a server computer 16a, 16b, 16c or 16d within the plurality of server computers 16a, 16b, 16c and 16d and install the update within the database 22a, 22b, 22c or 22d within the server computer 16a, 16b, 16c or 16d which receives the update. Thus, an intended end result of operation of the series of data transferors 26a, 26b, 26c and 26d, in conjunction with the series of update spies 24a, 24b, 24c and 24d, is a coincident update of all databases 22a, 22b, 22c and 22d within the series of server computers 16a, 16b, 16c and 16d when one of the databases 22a, 22b, 22c or 22d within the series of databases 22a, 22b, 22c or 22d is externally updated. Thus, for clarity, within the context of the present invention, a database update not received through a data transferor 26a, 26b, 26c or 26d may be regarded as an externally initiated update, while a database update received through a data transferor 26a, 26b, 26c or 26d may be regarded as an internally initiated update.

As is further illustrated, or at least implied, within the schematic block diagram of FIG. 2, each of the series of update spies 24a, 24b, 24c and 24c serves bidirectionally with respect to both sensing externally initiated database updates to the series of databases 22a, 22b, 22c and 22d, as well as providing and installing internally initiated database updates to the series of databases 22a, 22b, 22c and 22d.

Finally, within the preferred embodiment of the present invention with respect to the series of communications interfaces 28a, 28b, 28c and 28d, the series of communications interfaces 28a, 28b, 28c and 28d may be provided employing hardware components as are otherwise generally conventional in the art of computer systems fabrication, and more particularly server computer systems fabrication, including but not limited to hard wired communications interface hardware components and wireless communications interface hardware components.

As is understood by a person skilled in the art, although the schematic block diagram of FIG. 2 illustrates the series of update spies 24a, 24b, 24c and 24d, as well as the series of data transferors 26a, 26b, 26c and 26d, as independent components, they may similarly also be merged to provide a series of equivalent merged database update detection and installation utilities within the series of server computers 16a, 16b, 16c and 16d as illustrated within the schematic block diagram of FIG. 2.

As is finally illustrated within the schematic block diagram of FIG. 1, the series of data transferors 26a, 26b, 26c and 26d may also possess a data translation capability such as to effect both: (1) efficient operation of the series of servers 16a, 16b, 16c and 16d with respect to the series of clients 10a, 10b and 10c as illustrated within the schematic block diagram of FIG. 1; and (2) efficient update of the series of databases 22a, 22b, 22c and 22d with respect to each other. With respect to the foregoing desirable features, it has been determined experimentally within the context of the preferred embodiment of the present invention that the series of web smart engines 20a, 20b, 20c and 20d, as well as the series of databases 22a, 22b, 22c and 22d, are preferably programmed employing a PHP programming language, while an internal update of any of the databases 22a, 22b, 22c or 22d through the series of communication interfaces 28a, 28b, 28c and 28d is preferably undertaken while employing data packets programmed with an extensible markup language (XML) programming language.

With respect to the foregoing preferred programming language requirements, the PHP programming language is understood by a person skilled in the art as a server-side cross-platform hyper-text mark-up language (HTML) embedded scripting language which provides particularly desirable properties with respect to Internet distributed communications network applications. Similarly, the extensible markup language (XML) programming language is understood by a person skilled in the art as a more universal format for structuring documents and facilitating data transfer within computer systems, such as multi-server computer systems.

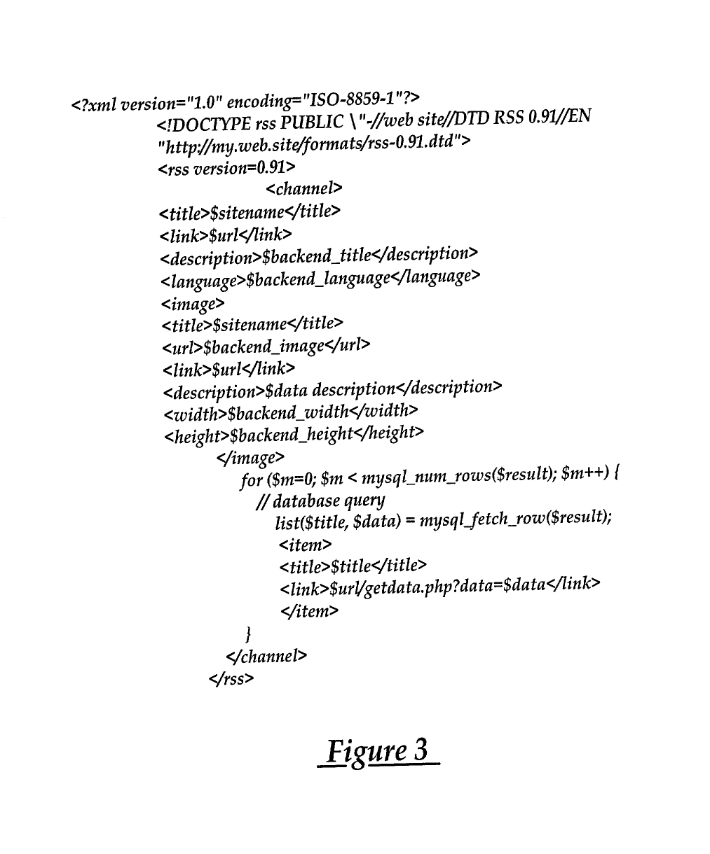

Referring now to FIG. 3, there is shown a series of lines of PHP-XML programming code which may be employed for programming a data transferor 26a, 26b, 26c and 26d in accord with the preferred embodiment of the present invention.

As is illustrated within the series of lines of programming code as shown within FIG. 3, and in particular within line 1 of the series of lines of programming code as shown within FIG. 3, it is indicated that the programming code is written at least in part employing an XML programming language. Similarly, and in accord with line 23 of the series of lines of programming code as shown within FIG. 3, it is indicated that database data which is transferred is originally provided in PHP programming language.

Upon providing a multi-server computer system as illustrated within the schematic diagrams of FIG. 1 and FIG. 2 and effecting within the multi-server computer system a database update in part in accord with the series of lines of programming code as shown within FIG. 3, there is provided by the present invention a multi-server computer system and a method for operating the multi-server computer system, wherein the multi-server computer system and the method for operating the multi-server computer system provide for enhanced database update and replication capabilities within the multi-server computer system.

The present invention realizes the foregoing objects by providing within the multi-server computer system of the present invention, and the method for operating the multi-server computer system of the present invention, and with respect to a plurality of server computers comprising a corresponding series of databases and a corresponding series of communications interfaces, a corresponding series of database update detection and installation utilities which serves to both: (1) automatically detect an externally initiated update to a database within the corresponding series of databases and automatically forward the externally initiated update to each of the remaining server computers within the plurality of server computers through the series of communications interfaces; and (2) automatically receive the externally initiated update through the series of communications interfaces from a server computer within the plurality of server computers and install the update within the remaining databases within the remaining server computers which receive the update through the series of communications interfaces.

As is understood by a person skilled in the art, the preferred embodiment of the present invention is illustrative of the present invention rather than limiting of the present invention. Revisions and modifications may be made to components and sub-systems employed within the context of the preferred embodiment of the present invention while still providing a multi-server computer system in accord with the present invention, and a method for operating the multi-server computer system in accord with the present invention, further in accord with the accompanying claims.

What is claimed is:

1. A multi-server computer system comprising:
a plurality of server computers comprising:
a corresponding series of databases;
a corresponding series of database update detection and installation utilities; and
a corresponding series of communications interfaces which connect the plurality of server computers with each other, wherein the series of database update detection and installation utilities serves to both:
automatically detect an externally initiated update to a database within the corresponding series of databases and automatically forward the externally initiated update to each of the remaining server computers within the plurality of server computers through the series of communications interfaces; and
automatically receive the externally initiated update through the series of communications interfaces from a server computer within the plurality of server computers and install the update within the remaining databases within the remaining server computers which receive the update through the series of communications interfaces.

2. The system of claim 1 wherein the series of communication interfaces comprises hard wired communication interfaces.

3. The system of claim 1 wherein the series of communication interfaces comprises wireless communication interfaces.

4. The system of claim 1 wherein:
the series of databases is programmed in a PHP programming language; and
the update is programmed in an XML programming language for transfer between the series of communications interfaces.

5. The system of claim 1 further comprising a router which routs incoming resource requests to the plurality of server computers.

6. The system of claim 5 wherein the router is connected to a distributed communications network.

7. The system of claim 6 wherein the distributed communications network is selected from the group consisting of local area networks distributed communications networks, wide area network distributed communications networks, Internet distributed communications networks and intranet distributed communications networks.

8. A method for operating a multi-server computer system comprising:
providing a multi-server computer system comprising a plurality of server computers comprising:
a corresponding series of databases;
a corresponding series of database update detection and installation utilities; and
a corresponding series of communications interfaces which connect the plurality of server computers with each other, wherein the series of database update detection and installation utilities serves to both:
automatically detect an externally initiated update to a database within the corresponding series of databases and automatically forward the externally initiated update to each of the remaining server computers within the plurality of server computers through the series of communications interfaces; and
automatically receive the externally initiated update through the series of communications interfaces from a server computer within the plurality of server computers and install the update within the remaining databases within the remaining server computers which receive the update through the series of communications interfaces; and
initiating the externally initiated update to the database within the series of databases such as to automatically update the remaining databases within the remaining server computers.

9. The method of claim 8 wherein the series of communication interfaces comprises hard wired communication interfaces.

10. The method of claim 8 wherein the series of communication interfaces comprises wireless communication interfaces.

11. The method of claim 8 wherein:
the series of databases is programmed in a PHP programming language; and
the update is programmed in an XML programming language for transfer between the series of communications interfaces.

12. The method of claim 8 further comprising a router which routs incoming resource requests to the plurality of server computers.

13. The method of claim 12 wherein the router is connected to a distributed communications network.

14. The method of claim 13 wherein the distributed communications network is selected from the group consisting of local area networks distributed communications networks, wide area network distributed communications networks, Internet distributed communications networks and intranet distributed communications networks.
